(19) United States
(12) Patent Application Publication
(10) Pub. No.: US 2023/0195762 A1
(43) Pub. Date: Jun. 22, 2023

(54) CLOSED LOOP ANALYSIS AND MODIFICATION SYSTEM FOR STEREOTYPE CONTENT

(71) Applicant: Gian Franco Wilson, Seattle, WA (US)

(72) Inventor: Gian Franco Wilson, Seattle, WA (US)

(21) Appl. No.: 18/069,612

(22) Filed: Dec. 21, 2022

Related U.S. Application Data
(60) Provisional application No. 63/292,352, filed on Dec. 21, 2021.

(51) Int. Cl. G06F 16/31

(52) U.S. Cl. CPC G06F 16/313

(57) ABSTRACT

A system is disclosed comprising a stereotype database and an SPI score generator application. The SPI score generator application comprises an SPI text parser, an SPI score type selector, and an SPI sentiment analyzer. The SPI text parser accepts a digital text data from a user, parses it, and indexes it. The SPI score type selector accepts a score type selection from the user and uses the score type selection to search the stereotype database for relevant stereotype vectors. The SPI sentiment analyzer analyzes the indexed digital text data using the relevant stereotype vectors to produce an SPI score output. The SPI score output is fed back to the stereotype database.

This application claims the benefit of U.S. provisional Pat. application serial no. 63/292,352, filed on Dec. 21, 2021, the contents of which are incorporated herein by reference in their entirety.

### BACKGROUND

Online and broadcast media has a large influence on individuals’ construction of social reality. For many, the media is the primary source of images for various characteristics that people belonging to other social groups and cultures possess, and the primary contact individuals may have with people from different social and cultural groups. There are challenges regarding learning people’s culture without any personal contact, not the least of which is the incomplete, inaccurate and biased interpretation of entire social groups that is often perpetrated. For example, certain ethnic, racial, and/or gender categories may be overrepresented as likely to perpetuate crime in the media.

Another challenge is that these cultural stereotypes often go unchallenged and result in real world consequences for the persons in the “other” social group. For example, exposure to inaccurate, stereotypical content of a particular racial, ethnic, and/or gender category may increase support for the death penalty and the three-strike law, and decrease support for affirmative action.

An individual’s experience, education, social environment, and consumption of media may create ideas and perceptions that they would be inclined to accept as fact, and the media may be a powerful influence for sharing cultures that many people may never have the opportunity to experience. However, without an appreciation for how perception interacts with reality, people may not recognize the limits of their perspectives. They may thus become suspicious of and reject any viewpoint that does not fit their version of reality. This rigidity and close-mindedness may be detrimental and harmful to minority groups.

There is a need, therefore, for a solution providing expeditious but comprehensive quantitative and qualitative analyses and closed-loop adjustment of content sources to assess how social groups are portrayed, and highlight where stereotypes are employed in their portrayal.

In an exemplary embodiment, a method includes receiving digital text data from a media data source to an SPI score generator application, where the SPI score generator application includes an SPI text parser, an SPI score type selector, and an SPI sentiment analyzer. The method may further include parsing and indexing the digital text data at the SPI text parser to generate indexed digital text data. The method may additionally include receiving a score type selection input from the media data source to the SPI score type selector, using the score type selection input at the SPI score type selector to search a stereotype database for a stereotype vector indicated by the score type selection input. The method may further include receiving the indexed digital text data from the SPI text parser and the stereotype vector from the stereotype database to the SPI sentiment analyzer, and generating a SPI score at the SPI sentiment analyzer using the indexed digital text data and the stereotype vector. The method may also include feeding the SPI score back to at least one of the stereotype database and the media data source.

In an exemplary embodiment, a system includes a media data source, a stereotype database and a computing apparatus with a processor. The computing apparatus also includes a memory storing instructions that, when executed by the processor, configure the apparatus to receive at least digital text data from the media data source to an SPI score generator application, where the SPI score generator application includes an SPI text parser, an SPI score type selector, and an SPI sentiment analyzer. The instructions may also configure the apparatus to parse and index the digital text data at the SPI text parser to generate indexed digital text data. The instructions may also configure the apparatus to receive a score type selection input from the media data source to the SPI score type selector, using the score type selection input at the SPI score type selector to search the stereotype database for a stereotype vector indicated by the score type selection input. The instructions may also configure the apparatus to receive the indexed digital text data from the SPI text parser and the stereotype vector from the stereotype database to the SPI sentiment analyzer. The instructions may also configure the apparatus to generate a SPI score at the SPI sentiment analyzer using the indexed digital text data and the stereotype vector, and feed the SPI score back to at least one of the stereotype database and the media data source.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a closed-loop digital system 100 in accordance with one embodiment.

FIG. 2 illustrates a routine 200 in accordance with one embodiment.

FIG. 3 depicts a client server network configuration 300 in accordance with one embodiment.

FIG. 4 depicts a machine 400 in the form of a computer system within which a set of instructions may be executed for causing the machine to perform any one or more of the methodologies discussed herein, according to an example embodiment.

FIG. 5 illustrates a convolutional neural network 500 in accordance with one embodiment.

FIG. 6 illustrates a convolutional neural network layers 600 in accordance with one embodiment.

FIG. 7 illustrates a VGG net 700 in accordance with one embodiment.

FIG. 8 illustrates a convolution layer filtering 800 in accordance with one embodiment.

FIG. 9 illustrates a pooling layer function 900 in accordance with one embodiment.

FIG. 10 illustrates a basic deep neural network 1000 in accordance with one embodiment.

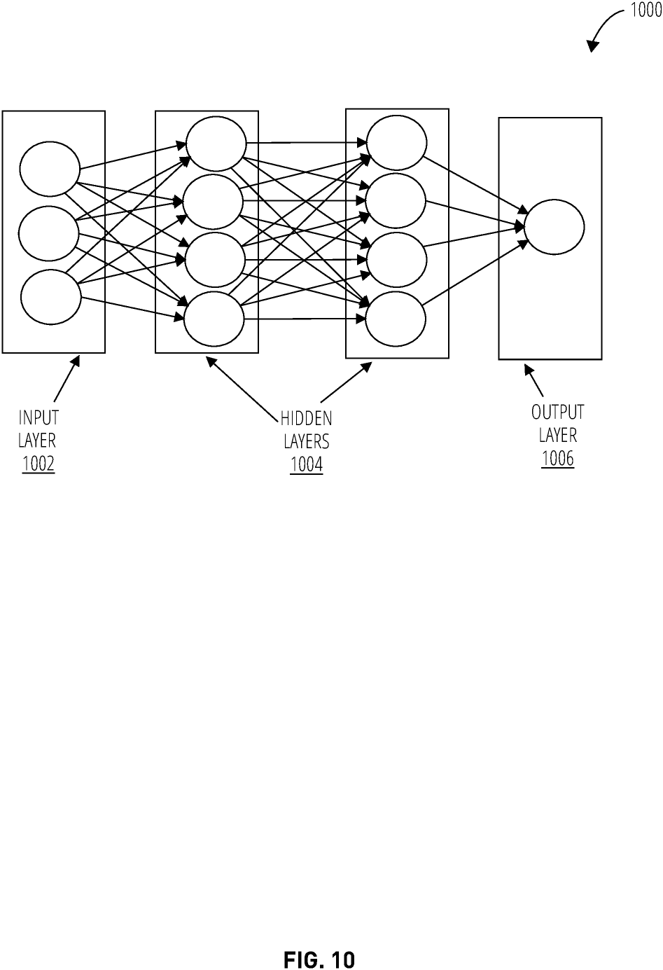

FIG. 11 illustrates an artificial neuron 1100 in accordance with one embodiment.

### DETAILED DESCRIPTION

Embodiments of a system and process are disclosed to analyze digital content sources to identify limited and/or biased representation of social groups. The system may be utilized to identify perceptions and depictions of cultural and social groups disseminated via digital content sources, to track the manner in which these images become normative, and to illuminate opportunities for persons within the cultural and social groups to challenge, correct, and add to the mainstream understanding of the group.

At a high level the system may comprise:
Stereotype database (SDB) - a comprehensive database that indexes stereotypes associated with a cultural group, including its history, contemporary use, and social impact.
Stereotype Perpetuation Index (SPI) - an algorithm utilizing artificial intelligence to generate SPI scores for news, entertainment and social media sources, according to their reliance on stereotypes.
Stereotype Countermeasure (SCM) - an application and closed-loop feedback mechanism to counter and correct incomplete and/or biased stereotypes in media sources.

### The Stereotype Database (SDB)

The stereotype database (SDB) may index stereotypes associated with a diversity group. It may map their origins and histories; record appearances of the stereotype in media; and reference academic and peer-reviewed theories on the impact of the stereotype on society. Users may submit stereotypes or representations to be considered for research and addition to the SDB. The SDB may be continually updated and readily available online.

With this information comprehensively and freely available online, the SDB may serve as a resource for content creators, students, researchers and the general public. It may be useful to the social understanding of how accurate a stereotype may actually be, how its use has evolved over time, and how it may have even impacted the evolution of society.

### The Stereotype Perpetuation Index (SPI)

The stereotype perpetuation index (SPI) utilizes artificial intelligence to generate SPI scores for media products (movies, television shows, books, news reports, articles, scripts and transcripts, etc.), according to their perpetuation of stereotypes. In one embodiment, the higher the score, the higher the use of stereotypes. SPI may use a word embeddings machine-learning framework that represents each word associated with a diversity group and its stereotypes by vector. With this, users may determine meaningful semantic relationships between a variety of words - particularly diversity groups and their associated stereotypes. This artificial intelligence technique may facilitate dynamic creation of an SPI score for any English language text. This may include, but may not be limited to, movie and television scripts, music lyrics, books, news and magazine articles, broadcast transcripts, close captioning libraries and social media posts. This SPI score may be used to analyze artificial intelligence reference databases being used to train neural networks.

The SPI may leverage the SDB to calculate the SPI score. Because the SDB may continually grow, media products’ SPIs may evolve as the SDB becomes more comprehensive.

### The Stereotype Perpetuation Index (SPI) Application Programming Interface (API)

The SPI platform may feature an application protocol interface (API) to extend the utility of the SPI to third-party platforms. Popular self-publishing social media platforms may license the SPI API to integrate alerting mechanisms into their platform. Users of platforms such as Facebook, YouTube, Medium and LinkedIn, may flag content as “perpetuating stereotypes,” and content creators may receive SPI reports with their score and links to information on the stereotypes identified.

### The Stereotype Countermeasure (SCM)

The SCM may in one embodiment be implemented as a downloadable mobile application that shares daily factoids to correct or complete mainstream stereotypes. The post may include links to an SDB article that gives an in-depth look at the stereotype being debunked. Users may subscribe to specific diversity groups and subscriptions to multiple diversity groups may factor into the content presented in the user’s feed. There is no subscription limit. Users may publish the factoids to their linked social media accounts, quickly and easily sharing the knowledge, and encouraging further research on the SDB website.

### The SPI Score Generator Application

The SPI score generator application may receive as an input a digital text data to determine how stereotypical the representation of diversity groups tracked in the stereotype database are within the text. By inputting the digital text data and selecting which type of SPI score they wish to have generated, a user may be presented with an SPI score, along with an annotated report based on the application’s analysis of the provided text. An alert may be generated based on the SPI score and applied to enhance the digital text data with warning or explanatory content, or automatically modify the content to reduce the SPI score in a closed-loop fashion. For each digital text data, its score and report, along with the date and time it was generated, may be stored in a SPI score generator database, so as to keep track of a text based data source’s score over time as it evolves.

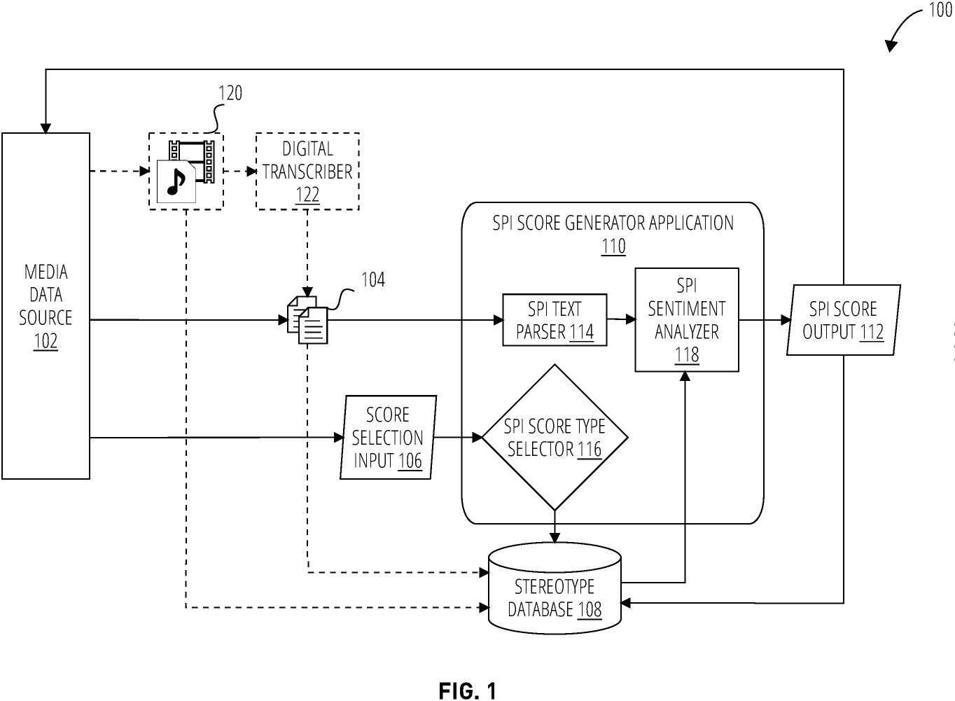

FIG. 1 depicts a closed-loop digital system 100 in accordance with one embodiment. The closed-loop digital system 100 comprises a media data source 102, digital text data 104, a score selection input 106, a stereotype database 108, an SPI score generator application 110, and an SPI score output 112. The SPI score generator application 110 further comprises an SPI text parser 114, an SPI score type selector 116, and an SPI sentiment analyzer 118.

Digital text data 104 (e.g., a link to content on a web server, or a digital document) may be provided by the media data source 102, and may be input to the SPI text parser 114 of the SPI score generator application 110. The SPI text parser 114 may analyze the digital text data 104, index it, and prepare it for SPI sentiment analysis.

The user may be prompted to select what type of SPI score to apply. In one embodiment, the user may select from the types of general SPI score, specific SPI score, and combination SPI score. The user’s score selection input 106 may be provided to the SPI score type selector 116 of the SPI score generator application 110.

The SPI score type selector 116 may access the stereotype database 108 using the API for that database. The relevant stereotype vectors collected from the stereotype database 108 may be directed to the SPI sentiment analyzer 118 portion of the SPI score generator application 110. The SPI text parser 114 may send the indexed and prepared digital text data 104 to the SPI sentiment analyzer 118 of the SPI score generator application 110 as well.

The SPI sentiment analyzer 118 may analyze the prepared and indexed digital text data 104 from the SPI text parser 114 using relevant stereotype vectors provided by the stereotype database 108. The SPI sentiment analyzer 118 may generate an SPI score output 112. The SPI score output 112 may be provided to the user. The SPI score output 112 may also be applied as a closed-loop control to modify the digital text data 104 provided by the media data source 102, and to the stereotype database 108 to improve database performance or train artificial intelligence neural networks. The digital text data 104 may be modified with highlighting to indicate content that had a particularly high impact on the SPI score output 112, enhanced with a warning of biased and/or stereotypical content, and/or automatically modified in a substantive sense to remove or re-word portions that contributed to the SPI score output 112.

In an embodiment, a user has the option of requesting a General SPI Score or a Specific SPI Score from the SPI Score Generator.

### The General SPI Score

In an exemplary embodiment, the General SPI Score has at least one component, and may be calculated as follows:
1. The SPI Sentiment Analysis Engine will find all instances of diversity groups found in the input text, and for each one of those instances determine if the descriptor vector is stereotypical.
2. Every instance of a stereotypical descriptor vector (i.e., also known as a stereotype vector) will be divided by all instances of diversity groups found, to give a percentage of stereotypical representation in the input text out of 100.

As a non-limiting example:
1. 38 instances of diversity groups are found in text; and
2. 12 instances of diversity groups found were described using a stereotypical descriptor vector.

The General SPI Score would be generated as follows:

$$\text{General SPI Score = 12/38} = 31.58 \%$$

### The Specific SPI Score

In an exemplary embodiment, if a Specific SPI score is requested, the score returned has at least 3 components for each diversity group identified:
Stereotypical Propensity (SPP) - For each instance of a diversity group identified in the input text, the number of times the descriptor vector is used to describe that diversity group stereotypical.
Stereotypical Compounding (SCPD) - For each instance of a diversity group identified in the input text being described using a stereotypical descriptor vector, the number of times the same stereotypical descriptor vector is used in the input text.
Stereotypical Comprehensiveness (SCPH)- For all instances of a diversity group identified in the input text, that used a stereotypical descriptor vector, the number of unique stereotypical descriptor vectors relative to all known stereotypical descriptor vector for the diversity group identified that were used in the input text.

As a non-limiting example:
1. 27 instances of references to the African American diversity group were found in the text;
2. 18 of these instances were found to be described using a stereotypical descriptor vector;
3. Of these 18 instances:
   1. instance (a) was used 11 times; and
   2. instance (b) was used 4 times
4. 5 unique stereotypical descriptor vectors were used of all 24 known stereotypical descriptor vectors used to describe African Americans

The Specific SPI Score as it relates to the African American diversity group would be generated as follows:

$$\text{SPP} = 18 / 27 = 66.67 \%$$

SCPD may be calculated as follows:
For every instance of compounding identified i.e., a stereotypical descriptor vector being used more than once, the number of instances of the same stereotypical descriptor vector being used, shall be divided by all stereotypical descriptor vectors used for the diversity group in the input text, to give a percentage out of 100. All such compounded instances will be calculated and then added together to give a score out of 100.
Instance (a) = 11/18 = 61.1%
Instance (b) = 4/18 = 22.2%
SCPD = 61.1% + 22.2% = 83.3%

The score may be reported as follows:

For the African American diversity group an exemplary Specific SPI Score is:

$$\text{SPP} = 66.67 \% \vert \text{SCPD=83} \text{.3\% \textbar SCPH} = 20.84 \%$$

In an embodiment, a complete Specific SPI Score report may include separate break out scores for each diversity group identified in the input text, along with associated commentary on each of the scores and how they were calculated for each group.

Exemplary pseudocode to calculate the SPI Scores is shown below:

dg means diversity group identifier.
sv means stereotypical vector.
function isStereotypical(x,y) {
boolean stereotypical;
stereotypical = consultDatabase(x,y);
return stereotypical;
}
function consultDatabase(x,y) {
boolean stereotypeFound;
stereotypeFound = executeQuery(“Select from SDB where
dg = x and where sv = y”);
return stereotypeFound;
}
dg = [array of all diversity groups identified in the text];
sv = [array stereotypical vectors]
for x in dg
y = sv.index(x)
isStereotypical(x,y);

In one embodiment, the media data source 102 may provide non-textual media 120 as well as digital text data 104. The non-textual media 120 may pass through a digital transcriber 122 in order to convert the non-textual media 120 to digital text data 104.

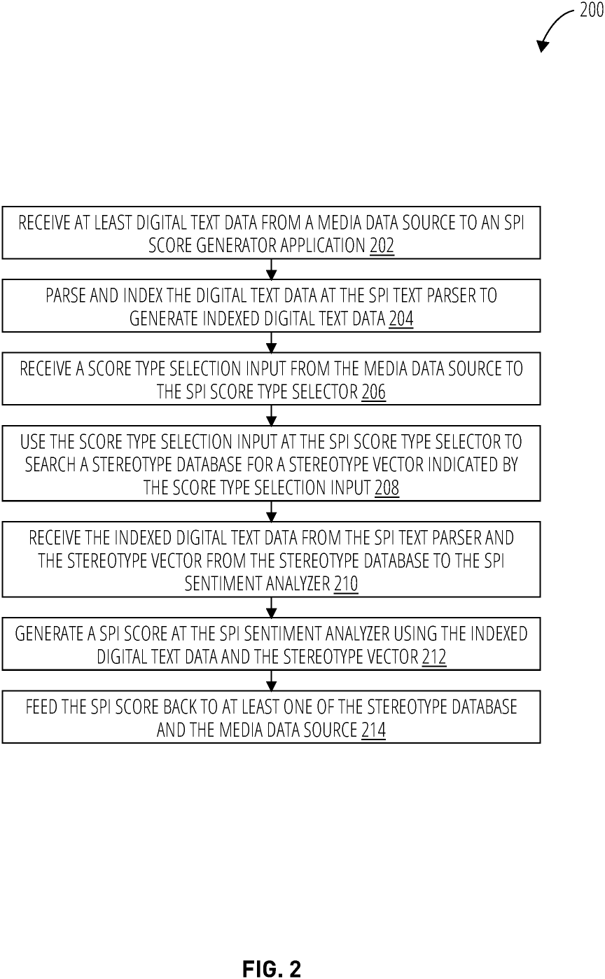

FIG. 2 illustrates an example routine 200 for implementing the disclosed solution using the closed-loop digital system 100 illustrated in FIG. 1. Although the example routine 200 depicts a particular sequence of operations, the sequence may be altered without departing from the scope of the present disclosure. For example, some of the operations depicted may be performed in parallel or in a different sequence that does not materially affect the function of the routine 200. In other examples, different components of an example device or system that implements the routine 200 may perform functions at substantially the same time or in a specific sequence.

According to some examples, the method includes receiving at least digital text data from a media data source to an SPI score generator application at block 202. The SPI score generator application may comprise an SPI text parser, an SPI score type selector, and an SPI sentiment analyzer. The media data source may be an individual user evaluating the digital text data consumed by that individual user. For example, a user may wish to evaluate articles, social media posts, or other digitally available texts for stereotypes contained therein, before or after beginning consumption. The media data source may also be a media-generating entity requesting evaluation of digital text data generated by the media-generating entity. For example, a newspaper or magazine may wish to have their articles evaluated before publication. In another example, a corporation may wish to have advertising copy evaluated for negative stereotypes before distribution to their markets.

The media data source may be a social media platform requesting annotation of the digital text data posted to the social media platform. For example, a social media platform may wish to append an informative caption or other annotation to posts made by their users containing negative stereotypes as part of their moderation process. The media data source may also be an algorithm configured to filter low-scoring media. For example, moderation by social media in such a use case may include removing or blocking posts that have a score indicating any negative stereotypes, or a score indicating the post meets or exceeds a threshold of number or severity of negative stereotypes, using such an algorithm.

According to some examples, the method includes receiving at a user interface application at least the digital text data from the media data source. The user interface application may then send a signal to at least one of the SPI score generator application and the stereotype database, the signal comprising at least the digital text data.

According to some examples, the method includes parsing and indexing the digital text data at the SPI text parser to generate indexed digital text data at block 204. According to some examples, the method includes receiving non-textual media from the media data source and passing the non-textual media through a digital transcriber to create the digital text data from the non-textual media. This digital text data may then be parsed by the SPI text parser.

According to some examples, the method includes receiving a score type selection input from the media data source to the SPI score type selector at block 206. According to some examples, the method includes receiving the score type selection input from the media data source at a user interface application. The user interface application may then send a signal to at least one of the SPI score generator application and the stereotype database, the signal comprising the score type selection input.

According to some examples, the method includes using the score type selection input at the SPI score type selector to search a stereotype database for a stereotype vector indicated by the score type selection input at block 208. According to some examples, the method includes sending the digital text data to the stereotype database for storage. According to some examples, sending the non-textual media to the stereotype database for storage.

According to some examples, the method includes receiving the indexed digital text data from the SPI text parser and the stereotype vector from the stereotype database to the SPI sentiment analyzer at block 210. According to some examples, the method includes generating a SPI score at the SPI sentiment analyzer using the indexed digital text data and the stereotype vector at block 212. In one embodiment, the digital text data comprises a plurality of media pieces and at least one SPI score is returned for each media piece of the plurality of media pieces. In one embodiment, the score type selection input is a predefined set of selections of interest to a user and a set of SPI scores is returned. According to some examples, the method includes annotating stereotypes as positive stereotypes and negative stereotypes. In this embodiment, the SPI score may be a two-part score indicating a prevalence of positive stereotypes and a prevalence of negative stereotypes.

According to some examples, the method includes feeding the SPI score back to at least one of the stereotype database and the media data source at block 214. According to some examples, the method includes annotating the digital text data stored in the stereotype database with the SPI score. According to some examples, the method includes annotating the non-textual media stored in the stereotype database with the SPI score. According to some examples, the method includes triggering an alert to the media data source based on the SPI score. According to some examples, the SPI score may be included in a publishable report to the media data source.

### Software Implementations

The systems disclosed herein, or particular components thereof, may in some embodiments be implemented as software comprising instructions executed on one or more programmable device. By way of example, components of the disclosed systems may be implemented as an application, an app, drivers, or services. In one particular embodiment, the system is implemented as a service that executes as one or more processes, modules, subroutines, or tasks on a server device so as to provide the described capabilities to one or more client devices over a network. However the system need not necessarily be accessed over a network and could, in some embodiments, be implemented by one or more app or applications on a single device or distributed between a mobile device and a computer, for example.

In another particular embodiment, the components of the closed-loop digital system 100 previously described may be implemented as software.

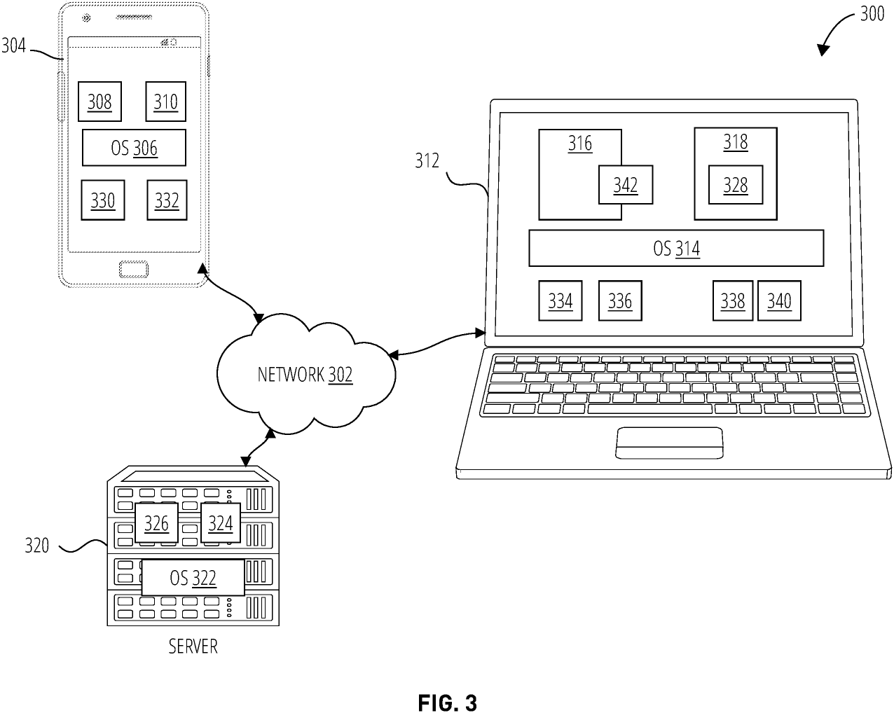

Referring to FIG. 3, a client server network configuration 300 illustrates various computer hardware devices and software modules coupled by a network 302 in one embodiment. Each device includes a native operating system, typically pre-installed on its non-volatile random access memory (RAM), and a variety of software applications or apps for performing various functions.

The mobile programmable device 304 comprises a native operating system 306 and various apps (e.g., app 308 and app 310). A computer 312 also includes an operating system 314 that may include one or more library of native routines to run executable software on that device. The computer 312 also includes various executable applications (e.g., application 316 and application 318). The mobile programmable device 304 and computer 312 are configured as clients on the network 302. A server 320 is also provided and includes an operating system 322 with native routines specific to providing a service (e.g., service 324 and service 326) available to the networked clients in this configuration.

As is well known in the art, an application, an app, or a service may be created by first writing computer code to form a computer program, which typically comprises one or more computer code sections or modules. Computer code may comprise instructions in many forms, including source code, assembly code, object code, executable code, and machine language. Computer programs often implement mathematical functions or algorithms and may implement or utilize one or more application program interfaces.

A compiler is typically used to transform source code into object code and thereafter a linker combines object code files into an executable application, recognized by those skilled in the art as an “executable”. The distinct file comprising the executable would then be available for use by the computer 312, mobile programmable device 304, and/or server 320. Any of these devices may employ a loader to place the executable and any associated library in memory for execution. The operating system executes the program by passing control to the loaded program code, creating a task or process. An alternate means of executing an application or app involves the use of an interpreter (e.g., interpreter 328).

In addition to executing applications (“apps”) and services, the operating system is also typically employed to execute drivers to perform common tasks such as connecting to third-party hardware devices (e.g., printers, displays, input devices), storing data, interpreting commands, and extending the capabilities of applications. For example, a driver 330 or driver 332 on the mobile programmable device 304 or computer 312 (e.g., driver 334 and driver 336) might enable wireless headphones to be used for audio output(s) and a camera to be used for video inputs. Any of the devices may read and write data from and to files (e.g., file 338 or file 340) and applications or apps may utilize one or more plug-in (e.g., plug-in 342) to extend their capabilities (e.g., to encode or decode video files).

The network 302 in the client server network configuration 300 may be of a type understood by those skilled in the art, including a Local Area Network (LAN), Wide Area Network (WAN), Transmission Communication Protocol/Internet Protocol (TCP/IP) network, and so forth. These protocols used by the network 302 dictate the mechanisms by which data is exchanged between devices.

### Machine Embodiments

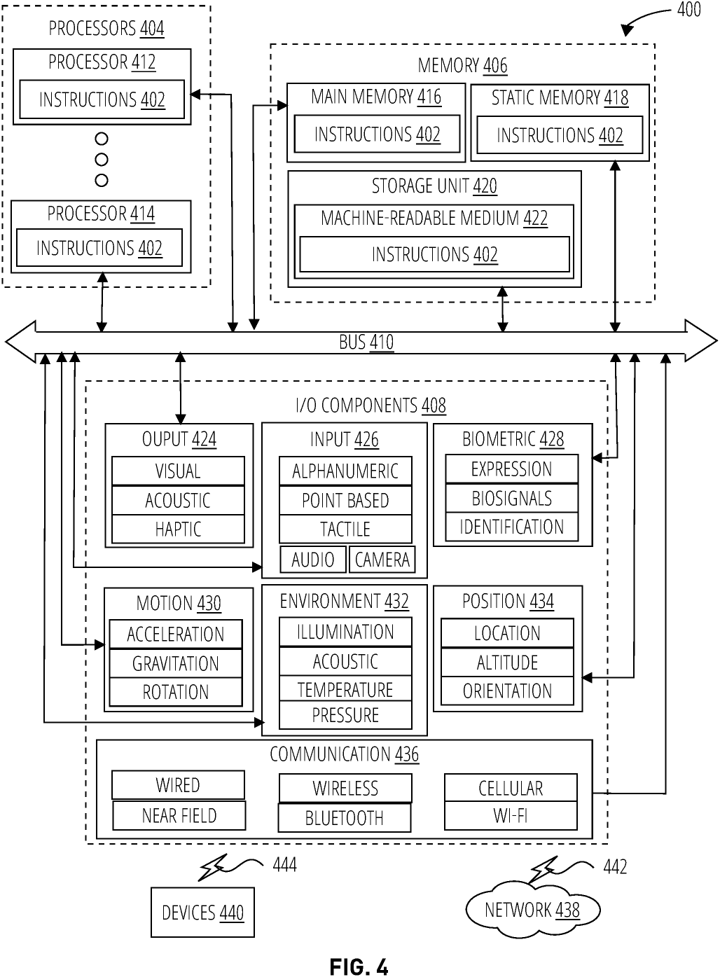

FIG. 4 depicts a diagrammatic representation of a machine 400 in the form of a computer system within which logic may be implemented to cause the machine to perform any one or more of the functions or methods disclosed herein, according to an example embodiment.

Specifically, FIG. 4 depicts a machine 400 comprising instructions 402 (e.g., a program, an application, an applet, an app, or other executable code) for causing the machine 400 to perform any one or more of the functions or methods discussed herein. For example the instructions 402 may cause the machine 400 to operate in accordance with aspects of the closed-loop digital system 100. The instructions 402 configure a general, non-programmed machine into a particular machine 400 programmed to carry out said functions and/or methods.

In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 402, sequentially or otherwise, that specify actions to be taken by the machine 400. Further, while a single machine 400 is depicted, the term “machine” shall also be taken to include a collection of machines that individually or jointly execute the instructions 402 to perform any one or more of the methodologies or subsets thereof discussed herein.

The machine 400 may include processors 404, memory 406, and I/O components 408, which may be configured to communicate with each other such as via one or more bus 410. In an example embodiment, the processors 404 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an application-specific integrated circuit (ASIC), a Radio-Frequency Integrated Circuit (RFIC), another processor, or any suitable combination thereof) may include, for example, one or more processor (e.g., processor 412 and processor 414) to execute the instructions 402. The term “processor” is intended to include multi-core processors that may comprise two or more independent processors (sometimes referred to as “cores”) that may execute instructions contemporaneously. Although FIG. 4 depicts multiple processors 404, the machine 400 may include a single processor with a single core, a single processor with multiple cores (e.g., a multi-core processor), multiple processors with a single core, multiple processors with multiples cores, or any combination thereof.

The memory 406 may include one or more of a main memory 416, a static memory 418, and a storage unit 420, each accessible to the processors 404 such as via the bus 410. The main memory 416, the static memory 418, and storage unit 420 may be utilized, individually or in combination, to store the instructions 402 embodying any one or more of the functionality described herein. The instructions 402 may reside, completely or partially, within the main memory 416, within the static memory 418, within a machine-readable medium 422 within the storage unit 420, within at least one of the processors 404 (e.g., within the processor’s cache memory), or any suitable combination thereof, during execution thereof by the machine 400.

The I/O components 408 may include a wide variety of components to receive input, provide output, produce output, transmit information, exchange information, capture measurements, and so on. The specific I/O components 408 that are included in a particular machine will depend on the type of machine. For example, portable machines such as mobile phones will likely include a touch input device or other such input mechanisms, while a headless server machine will likely not include such a touch input device. It will be appreciated that the I/O components 408 may include many other components that are not shown in FIG. 4. The I/O components 408 are grouped according to functionality merely for simplifying the following discussion and the grouping is in no way limiting. In various example embodiments, the I/O components 408 may include output components 424 and input components 426. The output components 424 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 426 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), one or more cameras for capturing still images and video, and the like.

In further example embodiments, the I/O components 408 may include biometric components 428, motion components 430, environmental components 432, or position components 434, among a wide array of possibilities. For example, the biometric components 428 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 430 may include acceleration sensor components (e.g., accelerometer), gravitation sensor components, rotation sensor components (e.g., gyroscope), and so forth. The environmental components 432 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 434 may include location sensor components (e.g., a global positioning satellite receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 408 may include communication components 436 operable to couple the machine 400 to a network 438 or devices 440 via a coupling 442 and a coupling 444, respectively. For example, the communication components 436 may include a network interface component or another suitable device to interface with the network 438. In further examples, the communication components 436 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 440 may be another machine or any of a wide variety of peripheral devices (e.g., a peripheral device coupled via a universal serial bus or USB).

Moreover, the communication components 436 may detect identifiers or include components operable to detect identifiers. For example, the communication components 436 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 436, such as location via Internet Protocol (IP) geolocation, location via Wi-FiⓇ signal triangulation, location via detecting an NFC beacon signal that may indicate a particular location, and so forth.

### Instruction and Data Storage Medium Embodiments

The various memories (i.e., memory 406, main memory 416, static memory 418, and/or memory of the processors 404) and/or storage unit 420 may store one or more sets of instructions and data structures (e.g., software) embodying or utilized by any one or more of the methodologies or functions described herein. These instructions (e.g., the instructions 402), when executed by processors 404, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors and internal or external to computer systems. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), field programmable gate arrays (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such intangible media, at least some of which are covered under the term “signal medium” discussed below.

Some aspects of the described subject matter may in some embodiments be implemented as computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular data structures in memory. The subject matter of this application may be practiced in a variety of system configurations, including hand-held devices, consumer electronics, general-purpose computers, more specialty computing devices, etc. The subject matter may also be practiced in distributed computing environments where tasks are performed by remote-processing devices that are linked through a communications network.

### Communication Network Embodiments

In various example embodiments, one or more portions of the network 438 may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 438 or a portion of the network 438 may include a wireless or cellular network, and the coupling 442 may be a Code Division Multiple Access (CDMA) connection, a Global System for Mobile communications (GSM) connection, or another type of cellular or wireless coupling. In this example, the coupling 442 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 402 and/or data generated by or received and processed by the instructions 402 may be transmitted or received over the network 438 using a transmission medium via a network interface device (e.g., a network interface component included in the communication components 436) and utilizing any one of a number of well-known transfer protocols (e.g., hypertext transfer protocol (HTTP)). Similarly, the instructions 402 may be transmitted or received using a transmission medium via the coupling 444 (e.g., a peer-to-peer coupling) to the devices 440. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 402 for execution by the machine 400, and/or data generated by execution of the instructions 402, and/or data to be operated on during execution of the instructions 402, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

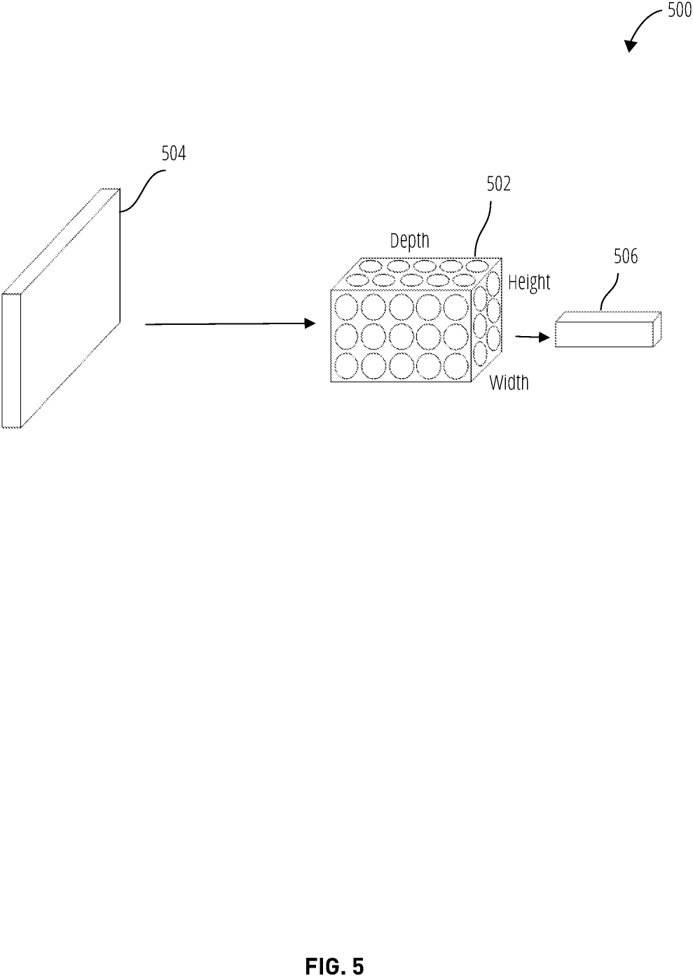

FIG. 5 illustrates an exemplary convolutional neural network 500. The convolutional neural network 500 arranges its neurons in three dimensions (width, height, depth), as visualized in convolutional layer 502. Every layer of the convolutional neural network 500 transforms a 3D volume of inputs to a 3D output volume of neuron activations. The following discussion of neural networks using images as an exemplary example. One of skill in the art would realize that text could be an input (i.e., input layer), and various portions of the text could be identified to have descriptor vectors that are stereotypical (e.g., classifications of the text content by the output layer).

In this example that utilizes an image, the input layer 504 encodes the image, so its width and height would be the dimensions of the image, and the depth would be 3 (e.g., Red, Green, Blue channels). The convolutional layer 502 further transforms the outputs of the input layer 504, and the output layer 506 transforms the outputs of the convolutional layer 502 into one or more classifications of the image content.

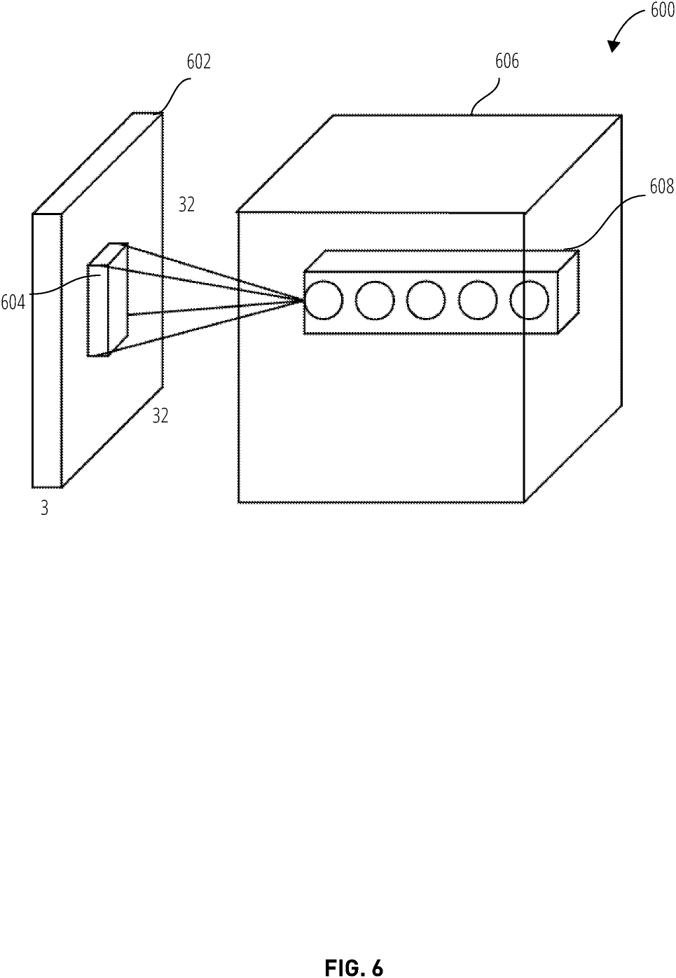

FIG. 6 illustrates an exemplary convolutional neural network layers 600 in more detail. An example subregion of the input layer region 604 of an input layer region 602 region of an image is analyzed by a set of convolutional layer subregion 608 in the convolutional layer 606. The input layer region 602 is 32 by 32 neurons long and wide (e.g., 32 by 32 pixels), and three neurons deep (e.g., three color channels per pixel). Each neuron in the convolutional layer 606 is connected to a local region in the input layer region 602 spatially (in height and width), but to the full depth (i.e. all color channels if the input is an image). Note, there are multiple neurons (5 in this example) along the depth of the convolutional layer subregion 608 that analyzes the subregion of the input layer region 604 of the input layer region 602, in which each neuron of the convolutional layer subregion 608 may receive inputs from every neuron of the subregion of the input layer region 604.

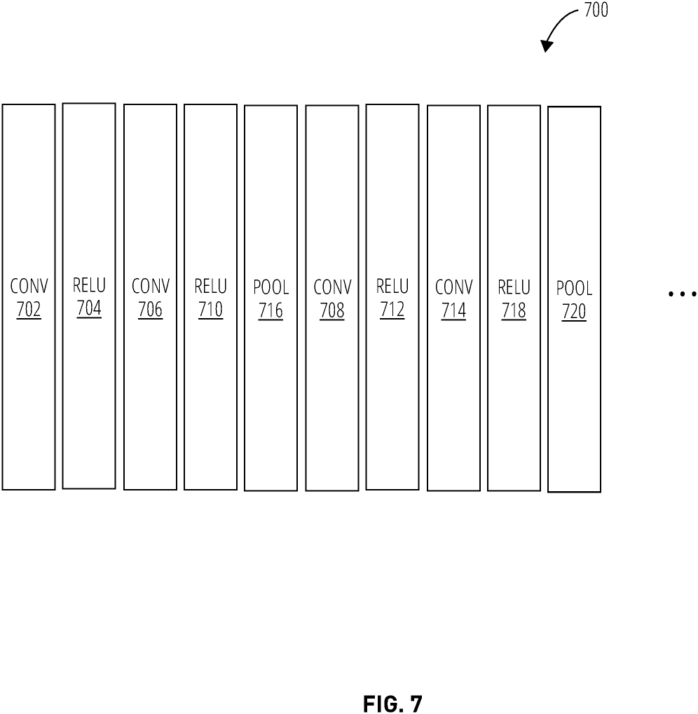

FIG. 7 illustrates a popular form of a CNN known as a visual geometry group network or VGG net 700. The initial convolution layer 702 stores the raw image pixels and the final pooling layer 720 determines the class scores. Each of the intermediate convolution layers ( convolution layer 706, convolution layer 708, and convolution layer 714) and rectifier activations ( RELU layer 704, RELUlayer 710, RELUlayer 712, and RELUlayer 718) and intermediate pooling layers (pooling layer 716, pooling layer 720) along the processing path is shown as a column.

The VGG net 700 replaces the large single-layer filters of basic CNNs with multiple 3 by 3 sized filters in series. With a given receptive field (the effective area size of input image on which output depends), multiple stacked smaller size filters may perform better at image feature classification than a single layer with a larger filter size, because multiple non-linear layers increase the depth of the network which enables it to learn more complex features. In a VGG net 700 each pooling layer may be 2 by 2.

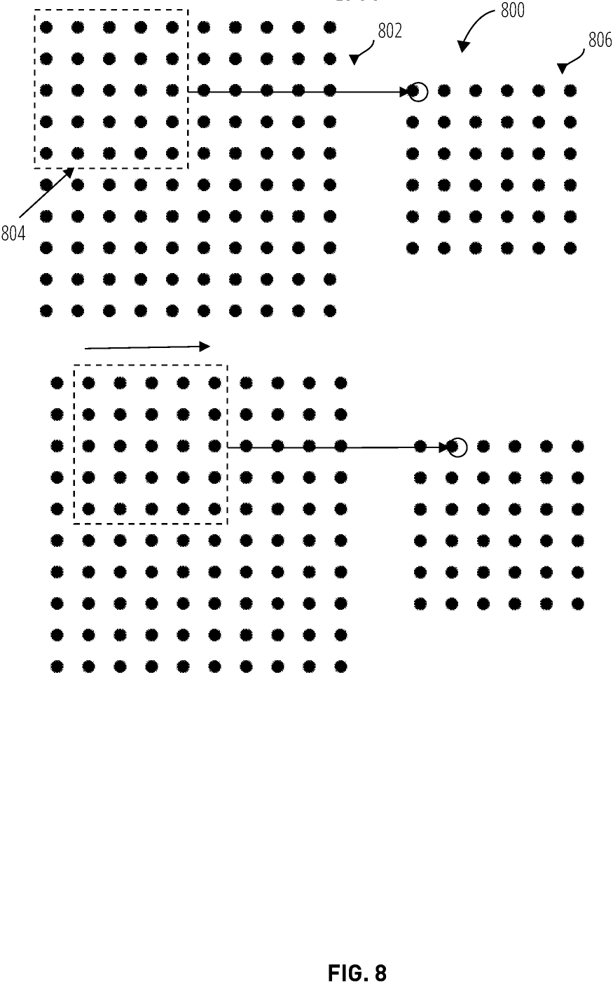

FIG. 8 illustrates a convolution layer filtering 800 that connects the outputs from groups of neurons in a convolution layer 802 to neurons in a next layer 806. A receptive field is defined for the convolution layer 802, in this example sets of 5 by 5 neurons. The collective outputs of each neuron the receptive field are weighted and mapped to a single neuron in the next layer 806. This weighted mapping is referred to as the filter 804 for the convolution layer 802 (or sometimes referred to as the kernel of the convolution layer 802). The filter 804 depth is not illustrated in this example (i.e., the filter 804 is actually a cubic volume of neurons in the convolution layer 802, not a square as illustrated). Thus what is shown is a “slice” of the full filter 804. The filter 804 is slid, or convolved, around the input image, each time mapping to a different neuron in the next layer 806. For example FIG. 8 shows how the filter 804 is stepped to the right by 1 unit (the “stride”), creating a slightly offset receptive field from the top one, and mapping its output to the next neuron in the next layer 806. The stride may be and often is other numbers besides one, with larger strides reducing the overlaps in the receptive fields, and hence further reducing the size of the next layer 806. Every unique receptive field in the convolution layer 802 that may be defined in this stepwise manner maps to a different neuron in the next layer 806. Thus, if the convolution layer 802 is 32 by 32 by 3 neurons per slice, the next layer 806 need only be 28 by 28 by 1 neurons to cover all the receptive fields of the convolution layer 802. This is referred to as an activation map or feature map. There is thus a reduction in layer complexity from the filtering. There are 784 different ways that a 5 by 5 filter may uniquely fit on a 32 by 32 convolution layer 802, so the next layer 806 need only be 28 by 28. The depth of the convolution layer 802 is also reduced from 3 to 1 in the next layer 806.

The number of total layers to use in a CNN, the number of convolution layers, the filter sizes, and the values for strides at each layer are examples of “hyperparameters” of the CNN.

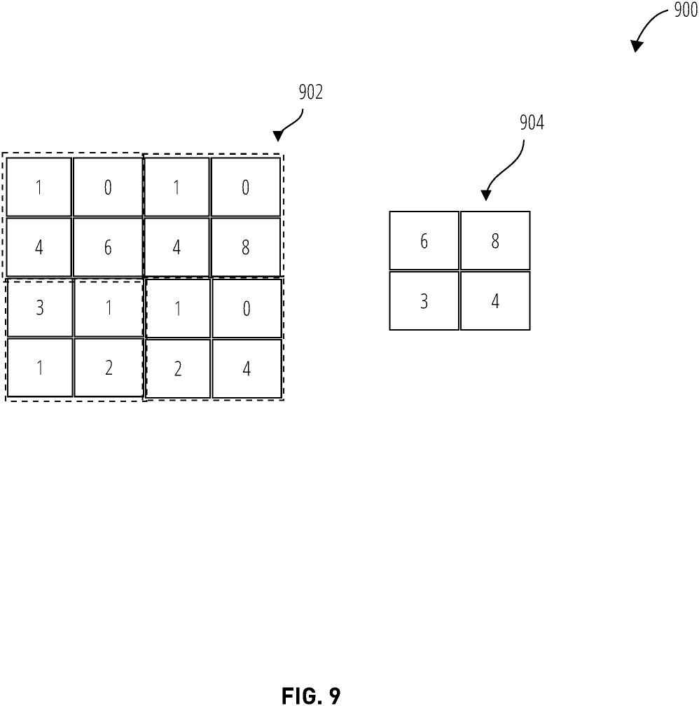

FIG. 9 illustrates a pooling layer function 900 with a 2 by 2 receptive field and a stride of two. The pooling layer function 900 is an example of the maxpool pooling technique. The outputs of all the neurons in a particular receptive field of the input layer 902 are replaced by the maximum valued one of those outputs in the pooling layer 904. Other options for pooling layers are average pooling and L2-norm pooling. The reason to use a pooling layer is that once a specific feature is recognized in the original input volume (there will be a high activation value), its exact location is not as important as its relative location to the other features. Pooling layers may drastically reduce the spatial dimension of the input layer 902 from that pont forward in the neural network (the length and the width change but not the depth). This serves two main purposes. The first is that the amount of parameters or weights is greatly reduced thus lessening the computation cost. The second is that it will control overfitting. Overfitting refers to when a model is so tuned to the training examples that it is not able to generalize well when applied to live data sets.

A basic deep neural network 1000 is based on a collection of connected units or nodes called artificial neurons which loosely model the neurons in a biological brain. Each connection, like the synapses in a biological brain, may transmit a signal from one artificial neuron to another. An artificial neuron that receives a signal may process it and then signal additional artificial neurons connected to it.

In common implementations, the signal at a connection between artificial neurons is a real number, and the output of each artificial neuron is computed by some non-linear function (the activation function) of the sum of its inputs. The connections between artificial neurons are called ‘edges’ or axons. Artificial neurons and edges typically have a weight that adjusts as learning proceeds. The weight increases or decreases the strength of the signal at a connection. Artificial neurons may have a threshold (trigger threshold) such that the signal is only sent if the aggregate signal crosses that threshold. Typically, artificial neurons are aggregated into layers. Different layers may perform different kinds of transformations on their inputs. Signals travel from the first layer (the input layer 1002), to the last layer (the output layer 1006), possibly after traversing one or more intermediate layers, called hidden layers 1004.

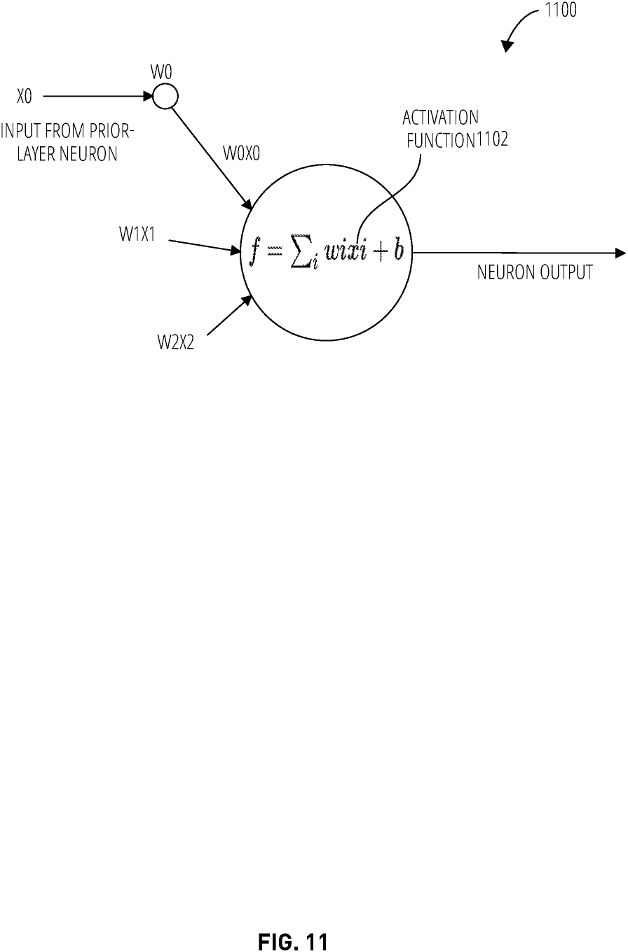

Referring to FIG. 11, an artificial neuron 1100 receiving inputs from predecessor neurons consists of the following components:
inputs xi;
weights wi applied to the inputs;
an optional threshold (b), which stays fixed unless changed by a learning function; and
an activation function 1102 that computes the output from the previous neuron inputs and threshold, if any.

An input neuron has no predecessor but serves as input interface for the whole network. Similarly an output neuron has no successor and thus serves as output interface of the whole network.

The network includes connections, each connection transferring the output of a neuron in one layer to the input of a neuron in a next layer. Each connection carries an input x and is assigned a weight w.

The activation function 1102 often has the form of a sum of products of the weighted values of the inputs of the predecessor neurons.

The learning rule is a rule or an algorithm which modifies the parameters of the neural network, in order for a given input to the network to produce a favored output. This learning process typically involves modifying the weights and thresholds of the neurons and connections within the network.

### LISTING OF DRAWING ELEMENTS

100 closed-loop digital system
102 media data source
104 digital text data
106 score selection input
108 stereotype database
110 SPI score generator application
112 SPI score output
114 SPI text parser
116 SPI score type selector
118 SPI sentiment analyzer
120 non-textual media
122 digital transcriber
200 routine
202 block
204 block
206 block
208 block
210 block
212 block
214 block
300 client server network configuration
302 network
304 mobile programmable device
306 operating system
308 app
310 app
312 computer
314 operating system
316 application
318 application
320 server
322 operating system
324 service
326 service
328 interpreter
330 driver
332 driver
334 driver
336 driver
338 file
340 file
342 plug-in
400 machine
402 instructions
404 processors
406 memory
408 I/O components
410 bus
412 processor
414 processor
416 main memory
418 static memory
420 storage unit
422 machine-readable medium
424 output components
426 input components
428 biometric components
430 motion components
432 environmental components
434 position components
436 communication components
438 network
440 devices
442 coupling
444 coupling
500 convolutional neural network
502 convolutional layer
504 input layer
506 output layer
600 convolutional neural network layers
602 input layer region
604 subregion of the input layer region
606 convolutional layer
608 convolutional layer subregion
700 VGG net
702 convolution layer
704 RELU layer
706 convolution layer
708 convolution layer
710 RELUlayer
712 RELUlayer
714 convolution layer
716 pooling layer
718 RELUlayer
720 pooling layer
800 convolution layer filtering
802 convolution layer
804 filter
806 next layer
900 pooling layer function
902 input layer
904 pooling layer
1000 basic deep neural network
1002 input layer
1004 hidden layers
1006 output layer
1100 artificial neuron
1102 activation function

“Algorithm” refers to any set of instructions configured to cause a machine to carry out a particular function or process.

“App” refers to a type of application with limited functionality, most commonly associated with applications executed on mobile devices. Apps tend to have a more limited feature set and simpler user interface than applications as those terms are commonly understood in the art.

“Application” refers to any software that is executed on a device above a level of the operating system. An application will typically be loaded by the operating system for execution and will make function calls to the operating system for lower-level services. An application often has a user interface but this is not always the case. Therefore, the term ‘application’ includes background processes that execute at a higher level than the operating system.

“Application program interface” refers to instructions implementing entry points and return values to a module.

“Assembly code” refers to a low-level source code language comprising a strong correspondence between the source code statements and machine language instructions. Assembly code is converted into executable code by an assembler. The conversion process is referred to as assembly. Assembly language usually has one statement per machine language instruction, but comments and statements that are assembler directives, macros, and symbolic labels may also be supported.

“Combination SPI score” refers to the score calculated by the SPI score generator application based on the prevalence of stereotypical representation in the digital text data relative to every type of stereotype found in the stereotype database within a specific combination of diversity groups. This allows a user to identify stereotypical prevalence where and understanding of intersectionality of diversity groups is required, for example, within the diversity group of “Black Women.”

“Compiled computer code” refers to object code or executable code derived by executing a source code compiler and/or subsequent tools such as a linker or loader.

“Compiler” refers to logic that transforms source code from a high-level programming language into object code or in some cases, into executable code.

“Computer code” refers to any of source code, object code, or executable code.

“Computer code section” refers to one or more instructions.

“Computer program” refers to another term for ‘application’ or ‘app’.

“Digital text data” refers to any data source in digital text format including but not limited to books, poems, essays, news and newspaper articles, magazine articles, film and television scripts, closed captioning files, music lyrics, social media posts, social media comments, reports, letters, memos, and research papers.

“Diversity group identifier” refers to a defined name, phrase or signifier for a diversity group found in the stereotype database.

“Driver” refers to low-level logic, typically software, that controls components of a device. Drivers often control the interface between an operating system or application and input/output components or peripherals of a device, for example.

“Executable” refers to a file comprising executable code. If the executable code is not interpreted computer code, a loader is typically used to load the executable for execution by a programmable device.

“Executable code” refers to instructions in a ready-to-execute form by a programmable device. For example, source code instructions in non-interpreted execution environments are not executable code because they must usually first undergo compilation, linking, and loading by the operating system before they have the proper form for execution. Interpreted computer code may be considered executable code because it may be directly applied to a programmable device (an interpreter) for execution, even though the interpreter itself may further transform the interpreted computer code into machine language instructions.

“File” refers to a unitary package for storing, retrieving, and communicating data and/or instructions. A file is distinguished from other types of packaging by having associated management metadata utilized by the operating system to identify, characterize, and access the file.

“General SPI score” refers to the score calculated by the SPI score generator application based on the prevalence of stereotypical representation in the digital text data relative to every type of stereotype found in the stereotype database across all diversity groups.

“Instructions” refers to symbols representing commands for execution by a device using a processor, microprocessor, controller, interpreter, or other programmable logic. Broadly, ‘instructions’ may mean source code, object code, and executable code. ‘instructions’ herein is also meant to include commands embodied in programmable read-only memories (EPROM) or hard coded into hardware (e.g., ‘micro-code’) and like implementations wherein the instructions are configured into a machine memory or other hardware component at manufacturing time of a device.

“Interpreted computer code” refers to instructions in a form suitable for execution by an interpreter.

“Interpreter” refers to an interpreter is logic that directly executes instructions written in a source code scripting language, without requiring the instructions to a priori be compiled into machine language. An interpreter translates the instructions into another form, for example into machine language, or into calls to internal functions and/or calls to functions in other software modules.

“Library” refers to a collection of modules organized such that the functionality of all the modules may be included for use by software using references to the library in source code.

“Linker” refers to logic that inputs one or more object code files generated by a compiler or an assembler and combines them into a single executable, library, or other unified object code output. One implementation of a linker directs its output directly to machine memory as executable code (performing the function of a loader as well).

“Loader” refers to logic for loading programs and libraries. The loader is typically implemented by the operating system. A typical loader copies an executable into memory and prepares it for execution by performing certain transformations, such as on memory addresses.

“Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Machine language” refers to instructions in a form that is directly executable by a programmable device without further translation by a compiler, interpreter, or assembler. In digital devices, machine language instructions are typically sequences of ones and zeros.

“Module” refers to a computer code section having defined entry and exit points. Examples of modules are any software comprising an application program interface, drivers, libraries, functions, and subroutines.

“Object code” refers to the computer code output by a compiler or as an intermediate output of an interpreter. Object code often takes the form of machine language or an intermediate language such as register transfer language (RTL).

“Operating system” refers to logic, typically software, that supports a device’s basic functions, such as scheduling tasks, managing files, executing applications, and interacting with peripheral devices. In normal parlance, an application is said to execute “above” the operating system, meaning that the operating system is necessary in order to load and execute the application and the application relies on modules of the operating system in most cases, not vice-versa. The operating system also typically intermediates between applications and drivers. Drivers are said to execute “below” the operating system because they intermediate between the operating system and hardware components or peripheral devices.

“Plug-in” refers to software that adds features to an existing computer program without rebuilding (e.g., changing or re-compiling) the computer program. Plug-ins are commonly used for example with Internet browser applications.

“Process” refers to software that is in the process of being executed on a device.

“Programmable device” refers to any logic (including hardware and software logic) who’s operational behavior is configurable with instructions.

“Service” refers to a process configurable with one or more associated policies for use of the process. Services are commonly invoked on server devices by client devices, usually over a machine communication network such as the Internet. Many instances of a service may execute as different processes, each configured with a different or the same policies, each for a different client.

“Software” refers to logic implemented as instructions for controlling a programmable device or component of a device (e.g., a programmable processor, controller). Software may be source code, object code, executable code, machine language code. Unless otherwise indicated by context, software shall be understood to mean the embodiment of said code in a machine memory or hardware component, including “firmware” and micro-code.

“Source code” refers to a high-level textual computer language that requires either interpretation or compilation in order to be executed by a device.

“Specific SPI score” refers to the score calculated by the SPI score generator application based on the prevalence of stereotypical representation in the digital text data relative to every type of stereotype found in the stereotype database within a specific diversity group, for example within the diversity group of “Black People,” or “Women.”

“SPI score” refers to a calculated weighted percentage score signifying the prevalence of stereotypical representations of a diversity group within a given text. The score may be reported as a General score or a Specific score. The score is determined based on how many times a diversity group was referenced or identified within a given text and the number of times that the representation was identified and recorded as being stereotypical or not. The more stereotypical the representation relative to the number of times the diversity group appears in the text, the higher the score. The less stereotypical the representation relative to the number of times the diversity group appears in the text, the lower the score. The SPI score will also come with an SPI score report. A specific score may include multiple components such as at least one of Stereotypical Propensity (SPP), Stereotypical Compounding (SDCPD), and Stereotypical Comprehensiveness (SCPH), but is not limited thereto.

“SPI score generator application” refers to the application which accepts inputs of a digital text data and SPI score type and generates an SPI score and SPI score report based on the specified inputs.

“SPI score report” refers to a detailed, automatically generated report, that annotates the provided digital text data, highlighting the diversity group identifiers and their associated stereotype vectors and their mathematical contributions to the overall SPI score. The annotations will link back to the stereotype database to provide additional context and insight on a given highlighted stereotype.

“SPI score type selector” refers to the option provided to a user to input the type of score they wish to have generated. A user may select a general SPI score, a specific SPI score based on a list of diversity groups, or a combination SPI score.

“SPI sentiment analyzer” refers to a process within the SPI score generator application, where the inputs of a parsed version of the user inputted digital text data which has been output from the SPI text parser; and a list of stereotype vectors and their associated diversity group identifiers generated from the stereotype database and supplied to the SPI score generator application via the stereotype database’s API based on the user’s selected SPI score type, are used to conduct sentiment vector analysis on the parsed text to generate an SPI score. The process takes the parsed text and scans it for diversity group identifiers. Once found, the process assesses the text for stereotypical representations for that diversity group. If a stereotypical representation if found, this is recorded by the process. If a stereotypical representation is not found, this is also recorded by the process.

“SPI text parser” refers to a process whereby the text parser ingests the digital text data in its native format, and, based on the type of text, indexes and prepares the original digital text data into an SPI score generator application format, complete with contextual information about the data source so that the parsed, indexed and prepared version of the data source may be analyzed by the SPI sentiment analyzer process.

“Stereotype database” refers to an open source database of stereotypes classified by diversity group with an application programming interface (API) allowing for the database to be queried based on specific input parameters.

“Stereotype vector” refers to a defined name for a stereotype found in the stereotype database and used within an identified diversity group. This may also be known as a stereotypical descriptor vector.

“Subroutine” refers to a module configured to perform one or more calculations or other processes. In some contexts the term ‘subroutine’ refers to a module that does not return a value to the logic that invokes it, whereas a ‘function’ returns a value. However herein the term ‘subroutine’ is used synonymously with ‘function’.

“Task” refers to one or more operations that a process performs.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A method comprising:
receiving at least digital text data from a media data source to a Stereotype Perpetuation Index (SPI) score generator application,
wherein the SPI score generator application comprises an SPI text parser, an SPI score type selector, and an SPI sentiment analyzer;
parsing and indexing the digital text data at the SPI text parser to generate indexed digital text data;
receiving a score type selection input from the media data source to the SPI score type selector;
using the score type selection input at the SPI score type selector to search a stereotype database for a stereotype vector indicated by the score type selection input;
receiving the indexed digital text data from the SPI text parser and the stereotype vector from the stereotype database to the SPI sentiment analyzer;
generating a SPI score at the SPI sentiment analyzer using the indexed digital text data and the stereotype vector; and
feeding the SPI score back to at least one of the stereotype database and the media data source.

2. The method of claim 1, further comprising:
sending the digital text data to the stereotype database for storage.

3. The method of claim 2, further comprising:
annotating the digital text data stored in the stereotype database with the SPI score.

4. The method of claim 1, further comprising:
receiving non-textual media from the media data source; and
passing the non-textual media through a digital transcriber to create the digital text data from the non-textual media.

5. The method of claim 4, further comprising:
sending the non-textual media to the stereotype database for storage; and
annotating the non-textual media stored in the stereotype database with the SPI score.

6. The method of claim 1, wherein the media data source is a social media platform requesting annotation of the digital text data posted to the social media platform.

7. The method of claim 1, wherein the SPI score is a specific SPI score including at least one of Stereotypical Propensity (SPP), Stereotypical Compounding (SDCPD), and Stereotypical Comprehensiveness (SCPH).

8. The method of claim 1, wherein the digital text data comprises a plurality of media pieces and at least one SPI score is returned for each media piece of the plurality of media pieces.

9. The method of claim 1, wherein the score type selection input is a predefined set of selections of interest to a user and a set of SPI scores is returned.

10. The method of claim 1, further comprising:
annotating stereotypes as positive stereotypes and negative stereotypes,
wherein the SPI score is a two-part score indicating a prevalence of positive stereotypes and a prevalence of negative stereotypes.

11. The method of claim 1, further comprising:
triggering an alert to the media data source based on the SPI score.

12. The method of claim 1, further comprising:
receiving at a user interface application at least the digital text data and the score type selection input from the media data source; and
sending a signal to at least one of the SPI score generator application and the stereotype database, the signal comprising at least the digital text data and the score type selection input.

13. A system comprising:
a media data source;
a stereotype database; and
a computing apparatus comprising:
a processor; and
a memory storing instructions that, when executed by the processor, configure the apparatus to:
receive at least digital text data from the media data source to a Stereotype Perpetuation Index (SPI) score generator application,
wherein the SPI score generator application comprises an SPI text parser, an SPI score type selector, and an SPI sentiment analyzer;
parse and index the digital text data at the SPI text parser to generate indexed digital text data;
receive a score type selection input from the media data source to the SPI score type selector;
using the score type selection input at the SPI score type selector to search the stereotype database for a stereotype vector indicated by the score type selection input;
receive the indexed digital text data from the SPI text parser and the stereotype vector from the stereotype database to the SPI sentiment analyzer;
generate a SPI score at the SPI sentiment analyzer using the indexed digital text data and the stereotype vector; and
feed the SPI score back to at least one of the stereotype database and the media data source.

14. The system of claim 13, wherein the instructions further configure the computing apparatus to:
send the digital text data to the stereotype database for storage.

15. The system of claim 14, wherein the instructions further configure the computing apparatus to:
annotate the digital text data stored in the stereotype database with the SPI score.

16. The system of claim 13, wherein the instructions further configure the computing apparatus to:
receive non-textual media from the media data source; and
pass the non-textual media through a digital transcriber to create the digital text data from the non-textual media.

17. The system of claim 13, wherein the SPI score is a specific SPI score including at least one of Stereotypical Propensity (SPP), Stereotypical Compounding (SDCPD), and Stereotypical Comprehensiveness (SCPH).

18. The system of claim 13, wherein the instructions further configure the computing apparatus to:
annotate stereotypes as positive stereotypes and negative stereotypes,
wherein the SPI score is a two-part score indicate a prevalence of positive stereotypes and a prevalence of negative stereotypes.

19. The system of claim 13, wherein the instructions further configure the computing apparatus to:
trigger an alert to the media data source based on the SPI score.

20. The system of claim 13, wherein the instructions further configure the computing apparatus to:
receive at a user interface application at least the digital text data and the score type selection input from the media data source; and
send a signal to at least one of the SPI score generator application and the stereotype database, the signal comprising at least the digital text data and the score type selection input.
